(19) United States
(12) Patent Application Publication
(10) Pub. No.: US 2002/0001755 A1
(43) Pub. Date: Jan. 3, 2002

(54) Lithium salt and a process of preparing thereof

(75) Inventors: Udo Heider, Riedstadt (DE); Michael Schmidt, Seeheim-Jugenheim (DE); Andreas Kuhner, Darmstadt (DE); Dagmar Petigk, Russelsheim (DE)

Correspondence Address: MILLEN, WHITE, ZELANO & BRANIGAN, P.C., 2200 CLARENDON BLVD., SUITE 1400, ARLINGTON, VA, 22201, US

(73) Assignee: MERCK PATENT GESELLSCHAFT, Darmstadt (DE)

(21) Appl. No.: 09/825,868

(22) Filed: Apr. 5, 2001

(30) Foreign Application Priority Data
Apr. 5, 2000 (DE) DE 10016801.9

(51) Int. Cl. H01M 10/40; C07F 9/06

(52) U.S. Cl. 429/324; 429/200; 556/24

(57) ABSTRACT

The invention can relate to lithium salts of the general formula (I)

Li[P(OR¹)ₐ(OR²)_{b}(OR³)_{c}(OR⁴)_{d}Fₑ] (I)

where 0<a+b+c+d≦5 and a+b+c+d+e=6 and R¹ to R⁴ are, independently of one another, alkyl, aryl or heteroaryl radicals, where at least two of R¹ to R⁴ may be directly bound to one another by a single or double bond, with the exception of lithium perfluoropinacolyltetrafluorophosphonate(V).

The lithium salts used according to the invention can have high oxidation potentials and may be suitable for nonaqueous electrolytes in electrochemical cells, in particular lithium ion batteries, having a high electrochemical stability.

The present invention relates to novel lithium salts, and a process for preparing them. The present invention may also relate to a nonaqueous electrolyte comprising such lithium salts, an electrochemical cell in which such a nonaqueous electrolyte is present and the use of the lithium salts as additives for lithium ion batteries.

In lithium ion batteries or lithium secondary batteries, fluorine-containing Li salts are usually used as electrolyte salts in the electrolyte. However, the LiPF₆ used most frequently as Li salt has the disadvantage of being a very hydrolysis-sensitive and thermally unstable substance. In contact with moist air or with residual water from, for example, the solvent likewise present in the electrolyte, it forms, inter alia, hydrogen fluoride (HF). Apart from its toxic properties, Hf has a serious adverse effect on the cycling behaviour and thus the performance of the battery system since metals, in particular manganese, can be leached from the electrodes used.

To avoid these disadvantages, alternative Li-compounds have been proposed, for example lithium imides, in particular lithium bis(trifluoromethylsulfonyl)imide, in U.S. Pat. No. 4,505,997 or lithium methanides, in particular lithium tris(trifluoromethylsulfonyl)methanide, in U.S. Pat. No. 5,273,840. These salts have a high anodic stability and form solutions having a high conductivity in organic carbonates. However, aluminium which is usually used as cathodic terminal lead in lithium ion batteries is not sufficiently passivated, at least by lithium imide. On the other hand, lithium methanide can be prepared and purified only with great difficulty. However, the use of impure lithium methanide adversely affects the electrochemical properties in respect of oxidation stability and passivation of aluminium.

As further alternatives, lithium spiroborates have been proposed in EP 0 698 301 and lithium spirophosphates have been proposed in Elektrochemical and Solid-State Letters, 2(2) 60-62 (1999). Owing to the use of bidentate ligands such as catechol, these salts have high thermal decomposition points of sometimes above 200° C. However, as an oxidation potential of not more than 4.3 V relative to Li/Li⁺, the electrochemical stability of these salts is not sufficient for use in lithium ion batteries having strongly oxidizing electrode materials such as LiMn₂O₄ or LiCo₁₋ₓNiₓO₂ (O<x<1).

### SUMMARY OF THE INVENTION

It is therefore a feature of the present invention to provide lithium salts which are suitable as electrolyte salts for electrolytes to be used in electrochemical cells, in particular lithium ion batteries, and avoid the disadvantages known in the prior art.

According to the invention, this feature may be achieved by the electrolyte salts of the present invention and a process for preparing them. In addition, such salts may be incorporated into a nonaqueous electrolyte or an electrochemical cell and used thereto. Generally, advantageous and preferred embodiments of the subject matter of the invention are indicated in the subordinate claims.

The invention accordingly provides lithium salts of the general formula (I)

Li[P(OR¹)ₐ(OR²)_{b}(OR³)_{c}(OR⁴)_{d}Fₑ] (I)

where 0<a+b+c+d≦5 and a+b+c+d+e=6 and R¹ to R⁴ are, independently of one another, alkyl, aryl or heteroaryl radicals, where at least two of R¹ to R⁴ may be directly bound to one another by a single or double bond, with the exception of lithium perfluoropinacolyltetrafluorophosphonate(V).

Chem. Ber. (1978), 111(9), 3105-11, describes reactions of an N-silylated iminophosphine with perfluronated ketones. In one of these reactions, lithium perfluoropinacolyltetrafluorophosphonate(V) is formed as by-product, but its properties or possible uses are not described.

Aryl radicals R¹ to R⁴ in the above formula (I) are preferably selected from the group consisting of phenyl, naphthyl, anthracenyl and phenanthrenyl radicals. Heteroaryl radicals R¹ to R⁴ in the above formula (I) are preferably selected from the group consisting of pyridyl, pyrazyl and pyrimidyl radicals.

The abovementioned alkyl, aryl and heteroaryl radicals for R¹ to R⁴ may have at least one halogen substituent, in particular fluorine, chlorine or bromine. The alkyl radicals contain, for example, from 1 to 10, in particular from 1 to 6, carbon atoms. The alkyl radicals can be linear or branched.

The aryl and heteroaryl radicals contain, for example, up to 10, in particular up to 6, carbon atoms. The aryl and heteroaryl radicals can likewise be substituted by at least one alkyl substituent having, for example, from 1 to 6 carbon atoms.

Preferably, the lithium salt of general formula (I) may be:

Li[P(OCH₂—CF₃)ₙF_{6-n] with} 1≦n≦5;

Li[P(OCH—(CF₃)₂)ₙF₆₋ₙ] with 1≦n≦5;

Li[P(OC—(CF₃)₃)ₙF₆₋ₙ] with 1≦n≦5;

Li[P(OC(CF₃)₂—C(CF₃)₂—O)₂F₂];

Li[P(OCF(CF₃)—CF₂—O)F₄]; or

Li[P(OCF(CF₃)—CF₂—O)₂F₂].

Optimally, the lithium salt of general formula (I) may be:

Li[P(OC(CF₃)₂—C(CF₃)₂—O)₂F₂];

Li[P(OCF(CF₃)—CF₂—O)F₄]; or

Li[P(OCF(CF₃)—CF₂—O)₂F₂].

According to the invention, it has surprisingly been found that the above-described lithium salts have a very high electrochemical stability. Furthermore, very high oxidation potentials of above 5.5 V relative to Li/Li⁺ can be achieved when such lithium salts are used as electrolyte salts in electrolytes. The use of, in particular, ligands derived from fluorinated organic diols, e.g. perfluoropinacol, gives lithium salts having very high thermal stability. The invention likewise provides a process for preparing lithium salts of the above-described general formula (I) by reacting a phosphorus(V) compound of the general formula (II)

P(OR¹)ₐ(OR²)_{b}(OR³)_{c}(OR⁴)_{d}Fₑ (II)

where 0<a+b+c+d≦5 and a+b+c+d+e=5, and R¹ to R⁴ are as defined above, with lithium fluoride in the presence of an organic solvent.

The reaction according to the invention is preferably carried out at temperatures in the range −20-60° C., particularly preferably 20-25° C., preferably for a period of 0.5-96 hours, particularly preferably about 24 hours.

The reaction according to the invention is carried out in the presence of organic solvents which are preferably selected from the group consisting of dimethyl carbonate, diethyl carbonate, propylene carbonate, ethylene carbonate, methyl ethyl carbonate, methyl propyl carbonate, γ-butyrolactone, methyl acetate, ethyl acetate, methyl propionate, ethyl propionate, methyl butyrate, ethyl butyrate, dimethyl sulfoxide, dioxolane, sulfolane, acetonitrile, acrylonitrile, dimethoxyethane, 1,2-butylene carbonate, 2,3-butylene carbonate, 1,3-dioxane, acetone and mixtures thereof. Particular preference is given to using mixtures of cyclic and acyclic solvents, e.g. ethylene carbonate together with open-chain carbonates. Very particular preference is given to mixtures of aprotic solvents, e.g. ethylene carbonate and diethyl carbonate and/or ethyl methyl carbonate.

Unlike the synthesis of LiPF₆, in which highly pure PF₅ gas which is difficult to obtain in large quantities is used, the preparation of the lithium salts of the invention is generally carried out using, as precursors, liquid or solid compounds of the above formula (II) which are easy to purify, for example by distillation or recrystallization.

Compounds of the formula (II) are described, for example, in the above-cited reference Chem. Ber. (1978), 111(9), 3105-11; and in Houben-Weyl, Methoden der organischen Chemie, phosphorus compounds I et seq.; in Zeitung Anorg. Allg. Chemie, Volume No. 533 (1986), 18-22, or in Zeitung Naturforschung, Volume 33b (1978), 131-135.

The preparation of the lithium salts of the invention is carried out in customary glass or plastic vessels, preferably in a reaction vessel consisting of polytetrafluoroethylene (PTFE).

The invention further provides a nonaqueous electrolyte for an electrochemical cell, capacitor, supercapacitor, primary and secondary batteries, preferably Li ion batteries, which comprises at least one lithium salt of the above formula (I), including lithium perfluoropinacolyltetrafluorophosphonate(V), as electrolyte salt or additive and also, if desired, at least one organic solvent.

The invention also provides a polymer electrolyte or gel electrolyte for an electrochemical cell, which comprises at least one lithium salt of the formula (I), including lithium perfluoropinacolyltetrafluorophosphonate(V), as electrolyte salt or additive.

The invention likewise provides a nonaqueous electrolyte for an electrochemical cell, capacitor, supercapacitor, primary and secondary batteries, preferably Li ion batteries, which comprises the reaction mixture obtained directly from the process of the invention. This embodiment is particularly advantageous, since it dispenses with the need to separate the lithium salt formed in the process of the invention from the solvent; instead, the reaction mixture comprising the lithium salt and solvent, in particular aprotic solvent, can be passed directly to use as electrolyte, for example in a lithium ion battery.

The accompanying drawing serves to explain the invention further. In the drawing,

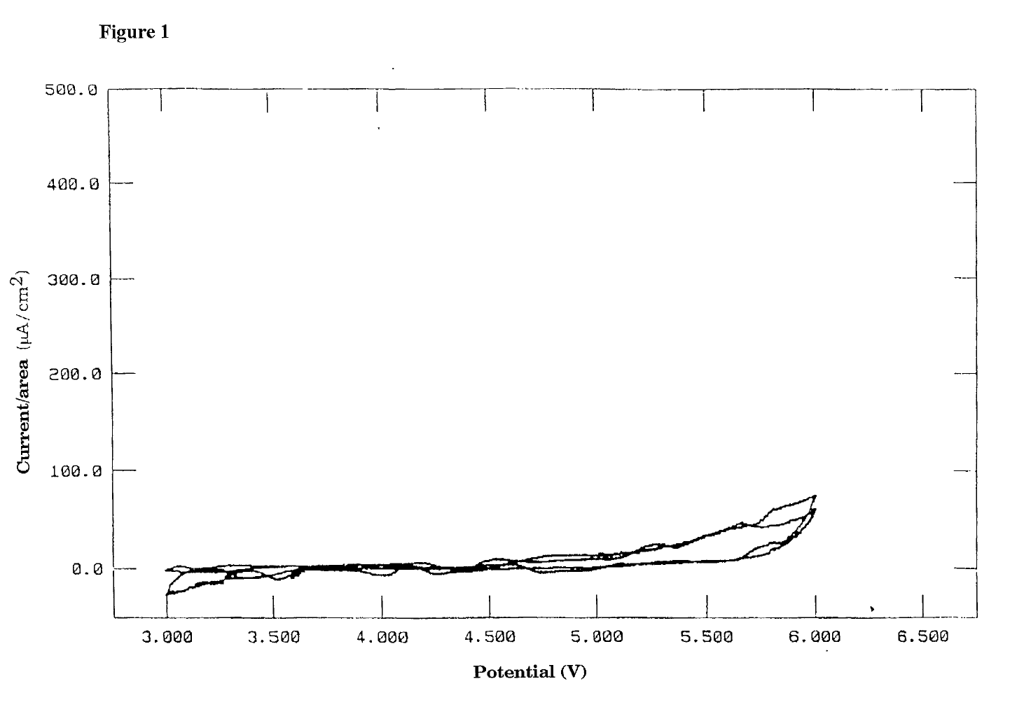

FIG. 1 shows a cyclic voltammogram of the measurement carried out in Example 2; and

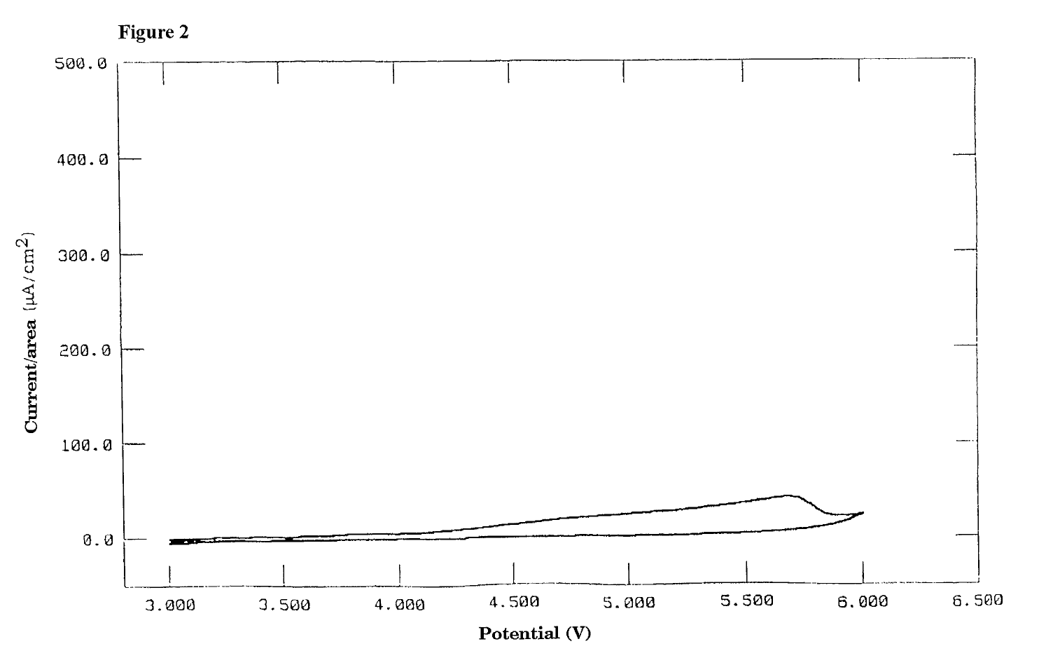

FIG. 2 shows a cyclic voltammogram of the measurement carried out in Example 4.

The nonaqueous electrolyte of the invention is particularly suitable for use in lithium ion batteries having a transition metal cathode.

The invention likewise provides an electrochemical cell comprising an anode, a cathode and an electrolyte according to the invention located between them.

Finally, the invention provides for the use of a lithium salt of the above formula (I), including lithium perfluoropinacolyltetrafluorophosphonate(V), or a lithium salt obtained by the process of the invention as additive in electrolytes for lithium ion batteries.

Generally an amount of about 0.1—about 3 mol/l, preferably an amount of about 0.1—about 1.5 mol/l, and optimally an amount of about 0.5—about 1.5 mol/l of the lithium salt of the present invention is added to a nonaqueous electrolyte.

The additives can be used together with conventional electrolyte salts in electrolytes. Suitable electrolytes comprise, for example, electrolyte salts selected from the group consisting of LiPF₆, LiBF₄, LiClO₄, LiAsF₆, LiCF₃SO₃, LiN(CF₃CF₂SO₂)₂, LiN(CF₃SO₂)₂ and LiC(CF₃SO₂)₃ and mixtures thereof. The electrolytes can further comprise organic isocyanates (DE 199 44 603) to reduce the water content. Likewise, the electrolytes may comprise organic alkali metal salts (DE 199 10 968) as additives. Suitable salts of this type are alkali metal borates of the general formula

Li⁺B⁻(OR¹)ₘ(OR²)ₚ

where,

m and p are each 0, 1, 2, 3 or 4 with m+p=4 and

R¹ and R² are identical or different,

may be joined directly to one another by a single or double bond,

are in each case either individually or together an aromatic or aliphatic carbonyl, dicarbonyl or sulfonyl group, or

are in each case either individually or together an aromatic ring selected from the group consisting of phenyl, naphthyl, anthracenyl and phenanthrenyl, which may be unsubstituted or monosubstituted to tetrasubstituted by A or Hal, or

are in each case either individually or together a heterocyclic aromatic ring selected from the group consisting of pyridyl, pyrazyl and bipyridyl, which may be unsubstituted or monosubstituted to trisubstituted by A or Hal, or

are in each case either individually or together an aromatic hydroxy acid selected from the group consisting of aromatic hydroxycarboxylic acids and aromatic hydroxysulfonic acids, which may be unsubstituted or monosubstituted to tetrasubstituted by A or Hal,

and

Hal is F, Cl or Br

and

A is alkyl having from 1 to 6 carbon atoms, which may be monohalogenated to trihalogenated. Likewise suitable are alkali metal alkoxides of the general formula

Li⁺OR⁻

where R

is an aromatic or aliphatic carbonyl, dicarbonyl or sulfonyl group, or

is an aromatic ring selected from the group consisting of phenyl, naphthyl, anthracenyl and phenanthrenyl, which may be unsubstituted or mono-substituted to tetrasubstituted by A or Hal, or

is a heterocyclic aromatic ring selected from the group consisting of pyridyl, pyrazyl and bipyridyl, which may be unsubstituted or mono-substituted to trisubstituted by A or Hal, or

is an aromatic hydroxy acid selected from the group consisting of aromatic hydroxycarboxylic acids and aromatic hydroxysulfonic acids, which may be unsubstituted or monosubstituted to tetrasubstituted by A or Hal,

and

Hal is F, Cl, or Br,

and

A is alkyl having from 1 to 6 carbon atoms, which may be mono-halogenated to trihalogenated.

It is also possible for lithium complex salts of the formula

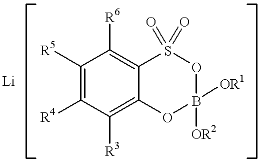

where

R¹ and R² are identical or different, may be joined directly to one another by a single or double bond and are in each case either individually or together an aromatic ring selected from the group consisting of phenyl, naphthyl, anthracenyl and phenanthrenyl, which may be unsubstituted or monosubstituted to hexasubstituted by alkyl (C₁ to C₆), alkoxy groups (C₁ to C₆) or halogen (F, Cl, Br),

or are in each case either individually or together an aromatic heterocyclic ring selected from the group consisting of pyridyl, pyrazyl and pyrimidyl, which may be unsubstituted or monosubstituted to tetrasubstituted by alkyl (C₁ to C₆), alkoxy groups (C₁ to C₆) or halogen (F, Cl, Br),

or are in each case either individually or together an aromatic ring selected from the group consisting of hydroxybenzenecarbonyl, hydroxynaphthalenecarbonyl, hydroxybenzenesulfonyl and hydroxynaphthalenesulfonyl, which may be unsubstituted or monosubstituted to tetra-substituted by alkyl (C₁ to C₆), alkoxy groups (C₁ to C₆) or halogen (F, Cl, Br),

R³-R⁶ can in each case either individually or in pairs, possibly joined directly to one another by a single or double bond, have the following meanings:

1. alkyl (C₁ to C₆), alkyloxy (C₁ to C₆) or halogen (F, Cl, Br)

2. an aromatic ring selected from the groups consisting of phenyl, naphthyl, anthracenyl and phenanthrenyl, which may be unsubstituted or monosubstituted to hexasubstituted by alkyl (C₁ to C₆), alkoxy groups (C₁ to C₆) or halogen (F, Cl, Br),

pyridyl, pyrazyl and pyrimidyl, which may be unsubstituted or monosubstituted to tetrasubstituted by alkyl (C₁ to C₆), alkoxy groups (C₁ to C₆) or halogen (F, Cl, Br),

which are prepared by the following process (DE 199 32 317)

a) 3-, 4-, 5-, 6-substituted phenol is treated in a suitable solvent with chlorosulfonic acid,

b) the intermediate from a) is reacted with chlorotrimethylsilane, filtered and fractionally distilled,

c) the intermediate from b) is reacted in a suitable solvent with lithium tetramethanolatoborate(1-), and the end product is isolated therefrom, to be present in the electrolyte.

Likewise, the electrolytes may comprise compounds of the following formula (DE 199 41 566)

[([R¹(CR²R³)ₖ]ₗAₓ)_{y}Kt]⁺ ⁻N(CF₃)₂

where

Kt=N, P, As, Sb, S, Se

A=N, P, P(O), O, S, S(O), SO₂, As, As(O), Sb, Sb(O)

R¹, R² and R³ are identical or different and are each

H, halogen, substituted or unsubstituted alkyl CₙH₂ₙ₊₁, substituted or unsubstituted alkenyl having 1-18 carbon atoms and one or more double bonds, substituted or unsubstituted alkynyl having 1-18 carbon atoms and one or more triple bonds, substituted or unsubstituted cycloalkyl CₘH₂ₘ₋₁, monosubstituted or polysubstituted or unsubstituted phenyl, substituted or unsubstituted heteroaryl,

A may be included in various positions in R¹, R² and/or R³,

Kt can be included in a cyclic or heterocyclic ring,

the groups bound to Kt may be identical or different,

where

n=1-18

m=3-7

k=0, 1-6

l=1 or 2 when x=1 and 1 when x=0

x=0, 1

y=1-4.

The process for preparing these compounds is characterized in that an alkali metal salt of the general formula

D^{+ -}N(CF₃)₂

where D⁺ is selected from the group consisting of the alkali metals, is reacted in a polar organic solvent with a salt of the general formula

[([R¹(CR²R³)ₖ]ₗAₓ)_{y}Kt]⁺ ⁻E

where

Kt, A, R¹, R², R³, k, l, x and y are as defined above and

⁻E is F⁻, Cl⁻, Br⁻, I⁻, BF₄⁻, ClO₄⁻, AsF₆⁻, SbF₆⁻ or PF₆⁻.

However, it is also possible to use electrolytes comprising compounds of the general formula (DE 199 53 638)

X—(CYZ)ₘ—SO₂N(CR¹R²R³)₂

where

X is H, F, Cl, CₙF₂ₙ₊₁, CₙF₂ₙ₋₁, (SO₂)ₖN(CR¹R²R³)₂

Y is H, F, Cl

Z is H, F, Cl

R¹, R², R³ are H and/or alkyl, fluoroalkyl, cycloalkyl

m is 0-9 and when X=H, m≠0

n is 1-9

k is 0 when m=0 and k=1 when m=1-9,

prepared by reacting partially fluorinated or perfluorinated alkysulfonyl fluorides with dimethylamine in organic solvents, or complex salts of the general formula (DE 199 51 804)

M^{X+}[EZ]_{x/y}^{y-}

where:

x, y are 1,2,3,4,5,6

M^{X+} is a metal ion

E is a Lewis acid selected from the group consisting of

BR¹R²R³, AlR¹R²R³, PR¹R²R³R⁴R⁵, AsR¹R²R³R⁴R⁵, VR¹R²R³R⁴R⁵,

R¹ to R⁵ are identical or different, may be joined directly to one another by a single or double bond, and are in each case either individually or together

a halogen (F, Cl, Br),

an alkyl or alkoxy radical (C₁ to C₈) which may be partially or fully substituted by F, Cl, Br,

an aromatic ring which may be bound via oxygen and is selected from the group consisting of phenyl, naphthyl, anthracenyl and phenanthrenyl, which may be unsubstituted or monosubstituted to hexasubstituted by alkyl (C₁ to C₈) or F, Cl, Br

an aromatic heterocyclic ring which may be bound via oxygen and is selected from the group consisting of pyridyl, pyrazyl and pyrimidyl, which may be unsubstituted or monosubstituted to tetrasubstituted by alkyl (C₁ to C₈) or F, Cl, and

Z is OR⁶, NR⁶R⁷, CR⁶R⁷R⁸, OSO₂R⁶, N(SO₂R⁶)(SO₂R⁷), C(SO₂R⁶)(SO₂R⁷)(SO₂R⁸), OCOR⁶, where

R⁶ to R⁸ are identical or different, may be bound directly to one another by a single or double bond, and are in each case either individually or together

a hydrogen atom or as defined for R¹ to R⁵, prepared by reacting an appropriate boron or phosphorus Lewis acid-solvent adduct with a lithium or tetraalkylammonium imide, methanide or triflate.

Borate salts (DE 199 59 722) of the general formula

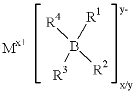

where:

M is a metal ion or a tetraalkylammonium ion

x,y are 1, 2, 3, 4, 5 or 6

R¹ to R⁴ are identical or different alkoxy or carboxyl radical (C₁-C₈) which may be bound directly to one another by a single or double bond, can also be present. These borate salts are prepared by reacting lithium tetraalkoxyborate or a 1:1 mixture of lithium alkoxide with a boric ester in an aprotic solvent with a suitable hydroxyl or carboxyl compound in a ratio of 2:1 or 4:1.

The additives can also be used in electrolytes comprising lithium fluoroalkylphosphates of the general formula:

Li⁺[PFₓ(C_{y}F_{2y+1-z}H_{z})₆₋ₓ]⁻

where

1≦x≦5

3≦y≦8

0≦z≦2y+1

and the ligands (C_{y}F_{2y+1-z}H_{z}) may be identical or different, with the compounds of the general formula,

Li⁺[PFₐ(CH_{b}F_{c}(CF₃)_{d})ₑ]⁻

in which a is an integer from 2 to 5, b=0 or 1, c=0 or 1, d=2 and

e is an integer from 1 to 4, with the proviso that b and c are not both 0 and the sum a+e=6 and the ligands (CH_{b}Fc(CF₃)_{d}) may be identical or different, being excluded (DE 100 089 55). The process for preparing lithium fluoroalkylphosphates of the above formula is characterized in that at least one compound of the general formula

HₘP(CₙH₂ₙ₊₁)_{3-m,}

OP(CₙH₂ₙ₊₁)₃,

ClₘP(CₙH₂ₙ₊₁)₃₋ₘ,

FₘP(CₙH₂ₙ₊₁)₃₋ₘ,

ClₒP(CₙH₂ₙ₊₁)₅₊ₒ,

FₒP(CₙH₂ₙ₊₁)₅₋ₒ,

in each of which

0≦m≦2, 3≦n≦8 and 0≦o≦4,

is fluorinated by electrolysis in hydrogen fluoride, the resulting mixture of fluorination products is fractionated by extraction, phase separation and/or distillation and the resulting fluorinated alkylphosphorane is reacted in an aprotic solvent or solvent mixture with lithium fluoride in the absence of moisture and the resulting salt is purified and isolated by customary methods.

Ionic liquids of the general formula

K⁺A⁻

where:

K⁺ is a cation selected from the group consisting of

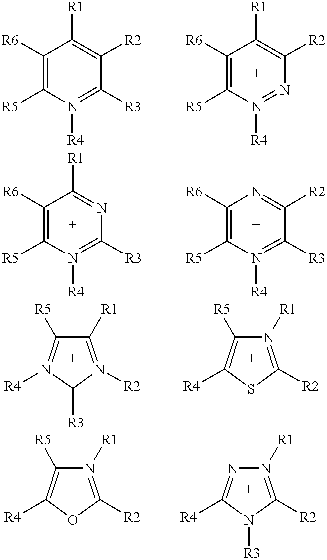

where R¹ to R⁵ are identical or different, may be joined directly to one another by a single or double bond and are in each case individually or together:

H,

halogen,

an alkyl radical (C₁ to C₈) which may be partially or fully substituted by further groups, preferably F, Cl, N(CₙF₍₂ₙ₊₁₋ₓ)Hₓ)₂, O(CₙF₍₂ₙ₊₁₋ₓ₎Hₓ), SO₂(CₙF₍₂ₙ₊₁₋ₓ₎Hₓ), CₙF₍₂ₙ₊₁₋ₓ₎Hₓ where 1<n<6 and 0<x≦13

and

A⁻ is an anion selected from the group consisting of

[B(OR¹)ₙ(OR²)ₘ(OR³)ₒ(OR⁴)ₚ]⁻

where 0≦n, m, o, p≦4 and

m+n+o+p=4

where R¹ to R⁴ are different or identical in pairs, may be joined directly to one another by a single or double bond, and are in each case either individually or together

an aromatic ring selected from the group consisting of phenyl, naphthyl, anthracenyl and phenanthrenyl, which may be unsubstituted or monosubstituted or polysubstituted by CnF_{(2n+1-X)}H_{X} where 1<n<6 and 0<x≦13 or halogen (F, Cl, Br),

an aromatic heterocyclic ring selected from the group consisting of pyridyl, pyrazyl and pyrimidyl, which may be unsubstituted or monosubstituted or polysubstituted by CₙF₍₂ₙ₊₁₋ₓ₎Hₓ where 1<n≦6 and 0<x≦13, or halogen (F, Cl, Br),

an alkyl radical (C₁ to C₈) which may be partially or fully substituted by further groups, preferably F, Cl, N(CₙF₍₂ₙ₊₁₋ₓ₎Hₓ)₂, O(CₙF₍₂ₙ₊₁₋ₓ₎Hₓ), SO₂(CₙF₍₂ₙ₊₁₋ₓ₎Hₓ, CₙF₍₂ₙ₊₁₋ₓ₎Hₓ where 1<n<6 and 0<x≦13,

or OR¹ to OR⁴

are in each case either individually or together an aromatic or aliphatic carboxyl, dicarboxyl, oxysulfonyl or oxycarboxyl group which may be partially or fully substituted by further groups, preferably F, Cl, N(CₙF₍₂ₙ₊₁₋ₓ₎Hₓ)₂, O(CₙF₍₂ₙ₊₁₋ₓ₎Hₓ), SO₂(CₙF₍₂ₙ₊₁₋ₓ₎Hₓ), CₙF₍₂ₙ₊₁₋ₓ₎Hₓ where 1<n<6 and 0<x≦13 (DE 100 265 65), can also be present in the electrolyte. It is also possible for ionic liquids K⁺ A⁻ where K⁺ is as defined above

A⁻ is an anion selected from the group consisting of

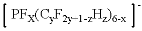

and

1≦x<6

1≦y<8 and

0≦z<2y+1,

may also be present (DE 100 279 95).

The compounds used according to the invention may also be present in electrolytes comprising compounds of the following formula:

NR¹R²R³

where

R¹ and R² are each H, C_{y}F_{2y+1-H}_{z} or (CₙF₂ₙ₋ₘHₘ)X, where X is an aromatic or heterocyclic radical, and

R³ is (CₙF₂ₙ₋ₘHₘ)Y, where Y is a heterocyclic radical, or (CₒF₂ₒ₋ₚHₚ)Z, where Z is an aromatic radical,

and n, m, o, p, y and z fulfil the following conditions:

0≦n≦6,

0≦m≦2n,

2≦o≦6,

0≦p≦2o,

1≦y≦8and

0≦z≦2y+1,

to reduce the acid content in aprotic electrolyte systems in electrochemical cells.

Fluoroalkylphosphates of the general formula

Mⁿ⁺[PFₓ(C_{y}F_{2y+1-z}H_{z})₆₋ₓ]ₙ⁻

where

1≦x≦6

1≦y≦8

0≦z≦2y+1

1≦n≦3and

Mⁿ⁺ is a monovalent to trivalent cation, in particular:

NR¹R²R³R⁴,

PR¹R²R³R⁴,

P(NR¹R²)ₖR³ₘR⁴₄₋ₖ₋ₘ (where k=1-4, m=0-3 and k+m≦4),

C(NR¹ R²)(NR³R⁴)(NR⁵R⁶),

C(Aryl)₃, Rb or tropylium,

where R¹ to R⁸ are each H, alkyl or aryl (C₁-C₈) which may be partially substituted by F, Cl or Br,

with Mⁿ⁺=Li⁺, Na⁺, Cs⁺, K⁺ and Ag⁺ being excluded, may also be present.

These fluoroalkylphosphates are obtainable by reacting phosphoranes with a fluoride or metal fluoroalkylphosphates with a fluoride or chloride in organic aprotic solvents (DE 100 388 58).

The electrolyte can also comprise a mixture comprising

a) at least one lithium fluoroalkylphosphate of the general formula

Li⁺[PF_{X}(C_{y}F_{2y+1-z}H_{z})₆₋ₓ]⁻

where

1≦x≦5

1≦y≦8and

0≦z≦2y+1

and the ligands (C_{y}F_{2y+1-z}H_{z}) are identical or different and

b) at least one polymer (DE 100 58 264).

The electrolyte may also comprise tetrakisfluoroalkylborate salts of the general formula

Mⁿ⁺([BR₄]⁻)ₙ

where

Mⁿ⁺ is a monovalent, divalent or trivalent cation,

the ligands R are identical and are each (CₓF₂ₓ₊₁) where 1≦x≦8, and n=1, 2 or 3 (DE 100 558 11). The process for preparing tetrakisfluoroalkylborate salts is characterized in that at least one compound of the general formula Mⁿ⁺([B(CN)₄]⁻)ₙ, where Mⁿ⁺ and n are as defined above, is fluorinated by reaction with at least one fluorinating agent in at least one solvent and the resulting fluorinated compound is purified and isolated by customary methods.

The electrolyte can also comprise borate salts of the general formula

Mⁿ⁺[BFₓ(C_{y}F_{2y+1-z}H_{z})₄₋ₓ]ₙ⁻

where:

1<x<3, 1≦y≦8 and 0≦z≦2y+1 and

M is a monovalent to trivalent cation (1≦n≦3), apart from potassium or barium,

in particular:

Li,

NR¹R²R³R⁴, PR⁵R⁶R⁷R⁸, P(NR⁵R⁶)ₖR⁷ₘR⁸₄₋ₖ₋ₘ (where k=1-4, m=0-3 and k+m≦4) or

C(NR⁵R⁶)(NR⁷R⁸)(NR⁹R¹⁰), where

R¹ to R⁴ are each C_{y}F_{2y+1-z}H_{z} and

R⁵ to R¹⁰ are each H or C_{y}F_{2y+1-z}H_{z} or

an aromatic heterocyclic cation, in particular a nitrogen- and/or oxygen- and/or sulfur-containing aromatic heterocyclic cation (DE 101 031 89). The process for preparing these compounds is characterized in that

a) BF₃-solvent complexes are reacted 1:1 with alkyllithium while cooling, the major part of the solvent is removed after slow warming and the solid is subsequently filtered off and washed with a suitable solvent, or

b) lithium salts are reacted 1:1 with B(CF₃)F₃⁻ in a suitable solvent, the mixture is stirred at elevated temperature and, after removing the solvent, the reaction mixture is admixed with aprotic nonaqueous solvents, preferably with solvents used in electrochemical cells, and dried, or

c) B(CF₃)F₃⁻ salts are reacted 1:1 to 1:1.5 with lithium salts in water at elevated temperature and heated at the boiling point for from 0.5 to 2 hours, the water is removed and the reaction mixture is admixed with aprotic nonaqueous solvents, preferably solvents which are used in electrochemical cells, and dried.

The electrolyte can also comprise fluoroalkylphosphate salts of the general formula

Mⁿ⁺([PFₓ(C_{y}F_{2y+1-z}H_{z})_{6-X}]⁻)ₙ

where

Mⁿ⁺ is a monovalent, divalent or trivalent cation,

1≦x≦5,

1≦y≦8and

0≦z≦2y+1, n=1, 2 or 3 and the ligands (C_{y}F_{2y+1-z}H_{z}) are identical or different, with the fluoroalkylphosphate salts in which Mⁿ⁺ is a lithium cation and the salts

M⁺([PF₄(CF₃)₂]⁻) where M⁺=Cs⁺, Ag⁺ or K⁺,

M⁺([PF₄(C₂F₅)₂]^{-) where M}⁺=Cs⁺,

M⁺([PF₃(C₂F₅)₃]⁻) where M⁺=Cs⁺, K⁺, Na⁺ or para-Cl(C₆H₄)N₂⁺,

M⁺([PF₃(C₃F₇)₃]⁻) where M⁺=Cs⁺, K⁺, Na⁺, para-Cl(C₆H₄)N₂⁺ or para-O₂N(C₆H₄)N₂⁺, being excluded (DE 100 558 12). The process for preparing these fluoroalkylphosphate salts is characterized in that at least one compound of the general formula

HᵣP(CₛH₂ₛ₊₁)₃₋ᵣ,

OP(CₛH₂ₛ₊₁)₃,

ClᵣP(CₛH₂ₛ₊₁)₃₋ᵣ,

FᵣP(CₛH₂ₛ₊₁)₃₋ᵣ,

ClₜP(CₛH₂ₛ₊₁)₅₋ₜ and/or

FₜP(H₂ₛ₊₁)₅₋ₜ,

where in each case

0≦r≦2

3≦s≦8 and

0≦t≦4,

is fluorinated by electrolysis in hydrogen fluoride, the resulting mixture of fluorination products is fractionated and the resulting fluorinated alkylphosphorane is reacted in an aprotic solvent or solvent mixture with a compound of the general formula Mⁿ⁺(F⁻)ₙ, where Mⁿ⁺ and n are as defined above, in the absence of moisture and the resulting fluoroalkylphosphate salt is purified and isolated by customary methods.

The additives can be used in electrolytes for electrochemical cells in which the anode materials consist of coated metal cores selected from the group consisting of Sb, Bi, Cd, In, Pb, Ga and tin and their alloys. The process for producing this anode material is characterized in that

a) a suspension or a sol of the metal or alloy core in urotropin is prepared,

b) the suspension is emulsified with C₅-C₁₂-hydrocarbons,

c) the emulsion is precipitated onto the metal or alloy cores and

d) the metal hydroxides or oxyhydroxides are converted into the corresponding oxide by heat treatment of the system.

The additives can also be used in electrolytes for electrochemical cells having cathodes comprising customary lithium intercalation and insertion compounds or else cathode materials which consist of lithium mixed oxide particles which have been coated with one or more metal oxides (DE 199 22 522) by suspending the particles in an organic solvent, admixing the suspension with a solution of a hydrolysable metal compound and a hydrolysis solution and then filtering off, drying and possibly calcining the coated particles. They can also consist of lithium mixed oxide particles which have been coated with one or more polymers (DE 199 46 066) and have been obtained by a process in which the particles are suspended in a solvent and the coated particles are subsequently filtered off, dried and possibly calcined. Likewise, the additives used according to the invention can be employed in systems whose cathodes consist of lithium mixed oxide particles which have been coated one or more times with alkali metal compounds and metal oxides. The process for producing these materials is characterized in that the particles are suspended in an organic solvent, an alkali metal salt suspended in an organic solvent is added, metal oxides dissolved in an organic solvent are added, the suspension is admixed with a hydrolysis solution and the coated particles are subsequently filtered off, dried and calcined.

Without further elaboration, it is believed that one skilled in the art can, using the preceding description, utilize the present invention to its fullest extent. The following preferred specific embodiments are, therefore, to be construed as merely illustrative, and not limitative of the remainder of the disclosure in any way whatsoever.

In the foregoing and in the following examples, all temperatures are set forth uncorrected in degrees Celsius; and, unless otherwise indicated, all parts and percentages are by weight.

The entire disclosure of all applications, patents and publications, cited above or below, and of corresponding German Application No. DE 10016801.9, filed Apr. 5, 2000 is hereby incorporated by reference.

### EXAMPLE 1

### Preparation of Lithium Perfluoropinacolyltetrafluorophosphonate(V)

A mixture of 0.47 g (18 mmol) of LiF and 9 ml of ethylene carbonate/dimethyl carbonate (1:1) is placed in a reaction vessel consisting of PTFE, and 7.56 g (18 mmol) of perfluoropinacolyltrifluorophosphorane are then added. The mixture is reacted for 24 hours at room temperature while stirring. The resulting solution comprising the desired lithium salt as electrolyte salt can be used directly as battery electrolyte.

### EXAMPLE 2

### Measurement of the Electrochemical Stability

Using the reaction solution from Example 1 as electrolyte, 5 cyclic voltammograms are recorded in succession in a measurement cell provided with a platinum electrode, a lithium counterelectrode and a lithium reference electrode. In these measurements, the potential is firstly increased from the rest potential to 6 V relative to Li/Li⁺ at a rate of 10 mV/s and subsequently brought back to the rest potential.

This gives the characteristic curve shown in FIG. 1. Even at a potential of above 55 V relative to Li/Li⁺, very low current densities of 50 μA/cm² are found. The electrolyte is thus suitable for use in lithium ion batteries having a transition metal cathode.

### Example 3

### Preparation of Lithium bis(perfluoropinacolyl)difluoro-phosphonate(V)

A mixture of 0.26 g (10 mmol) of LiF and 5 ml of ethylene carbonate/dimethyl carbonate (1:1) is placed in a reaction vessel consisting of PTFE, and 7.14 g (10 mmol) of bis(perfluoropinacolyl)-fluorophosphorane are then added. The mixture is reacted for 24 hours at room temperature while stirring. The resulting solution comprising the desired lithium salt as electrolyte salt can be used directly as battery electrolyte.

### EXAMPLE 4

### Measurement of the Electrochemical Stability

Using the reaction solution from Example 3 as electrolyte, 5 cyclic voltammograms are recorded in succession in a measurement cell provided with a platinum electrode, a lithium counterelectrode and a lithium reference electrode. In these measurements, the potential is firstly increased from the rest potential to 6 V relative to Li/Li⁺ at a rate of 10 mV/s and subsequently brought back to the rest potential.

This gives the characteristic curve shown in FIG. 2. Even at a potential of above 5.8 V relative to Li/Li⁺, very low current densities of 50 μA/cm² are found. The electrolyte is thus suitable for use in lithium ion batteries having a transition metal cathode.

The preceding examples can be repeated with similar success by substituting the generically or specifically described reactants and/or operating conditions of this invention for those used in the preceding examples.

From the foregoing description, one skilled in the art can easily ascertain the essential characteristics of this invention and, without departing from the spirit and scope thereof, can make various changes and modifications of the invention to adapt it to various usages and conditions.

1. A lithium salt of the formula (I)
Li[P(OR¹)ₐ(OR²)_{b}(OR³)_{c}(OR⁴)_{d}Fₑ] (I)
where 0<a+b+c+d≦5 and a+b+c+d+e=6 and R¹ to R⁴ are, independently of one another, an alkyl, an aryl or a heteroaryl radical, where at least two of R¹ to R⁴ may be directly bound to one another by a single or double bond, with the exception of lithium perfluoropinacolyltetrafluorophosphonate(V).

2. A lithium salt according to claim 1, wherein the aryl radical is a phenyl, a naphthyl, an anthracenyl or a phenanthrenyl radical.

3. A lithium salt according to claim 1, wherein the heteroaryl radical is a pyridyl, a pyrazyl or a pyrimidyl radical.

4. A lithium salt according to claim 1, wherein the alkyl, aryl or heteroaryl radical has at least one halogen substituent.

5. A lithium salt according to claim 1, wherein the aryl or heteroaryl radical has at least one alkyl substituent having up to 6 carbon atoms.

6. A process for preparing a lithium salt according to claim 1 comprising reacting a phosphorus(V) compound of the general formula (II)
P(OR¹)ₐ(OR²)_{b}(OR³)_{c}(OR⁴)_{d}Fₑ (II)
where 0<a+b+c+d≦5 and a+b+c+d+e=5, and R¹ to R⁴are, independently of one another, an alkyl, an aryl or a heteroaryl radical, where at least two of R¹ to R⁴ may be directly bound to one another by a single or double bond, with the exception of lithium perfluoropinacolyltetrafluorophosphonate(V), with lithium fluoride in the presence of an organic solvent.

7. A process according to claim 6, wherein the reaction is carried out from about −20- about 60° C., for from about 0.5 about 36 hours.

8. A process according to claim 6, wherein the organic solvent is a dimethyl carbonate, a diethyl carbonate, a propylene carbonate, an ethylene carbonate, a methyl ethyl carbonate, a methyl propyl carbonate, a γ-butyrolactone, a methyl acetate, an ethyl acetate, a methyl propionate, an ethyl propionate, a methyl butyrate, an ethyl butyrate, a dimethyl sulfoxide, a dioxolane, a sulfolane, an acetonitrile, an acrylonitrile, a dimethoxyethane, a 1,2-butylene carbonate, a 2,3-butylene carbonate, a 1,3-dioxane, an acetone or a mixture thereof.

9. A process according to claim 6, wherein the organic solvent used is a mixture of a cyclic and an acyclic carbonate.

10. A process according to claim 6, wherein the organic solvent used is a mixture of an ethylene carbonate and a diethyl carbonate and/or an ethyl methyl carbonate.

11. A nonaqueous electrolyte for an electrochemical cell, comprising at least one lithium salt of the formula (I)
Li[P(OR¹)ₐ(OR²)_{b}(OR³)_{c}(OR⁴)_{d}Fₑ] (I)
where 0<a+b+c+d≦5 and a+b+c+d+e=6 and R¹ to R⁴ are, independently of one another, an alkyl, an aryl or a heteroaryl radical, where at least two of R¹ to R⁴ may be directly bound to one another by a single or double bond, and, optionally at least one organic solvent.

12. A nonaqueous electrolyte for an electrochemical cell, comprising a reaction mixture obtained by the process according to claim 6.

13. An electrochemical cell, comprising an anode, a cathode and a nonaqueous electrolyte according to claim 11.

14. An electrochemical cell, a supercapacitor or a lithium ion battery comprising a lithium salt according to claim 1.

15. A process according to claim 7, wherein the reaction is carried out from about 20- about 25° C.

16. A process according to claim 7, wherein the reaction is carried out for about 24 hours.

17. A lithium ion battery comprising an electrochemical cell according to claim 13.

18. A lithium salt according to claim 1 wherein the aryl or heteroaryl radical has up to 10 carbon atoms.

19. A lithium salt according to claim 1 wherein the alkyl radical has up to 10 carbon atom.

20. A lithium salt according to claim 1 wherein the aryl or heteroaryl radical has up to 6 carbon atoms.
